(19) United States
(12) Patent Application Publication
(10) Pub. No.: US 2017/0339765 A1
(43) Pub. Date: Nov. 23, 2017

(54) LIGHTING SYSTEM BUILT-IN INTELLIGENCE

(71) Applicant: Lunera Lighting, Inc., Santa Clara, CA (US)

(72) Inventors: Donald Barnetson, San Jose, CA (US); Josef Kirmeier, Los Gatos, CA (US); Joel Snook, Grass Valley, CA (US)

(21) Appl. No.: 15/669,122

(22) Filed: Aug. 4, 2017

Related U.S. Application Data
(63) Continuation-in-part of application No. 14/147,607, filed on Jan. 6, 2014.

(51) Int. Cl. H05B 33/08; H05B 37/02

(52) U.S. Cl. CPC H05B 33/0854; H05B 33/0815; H05B 33/0812; H05B 37/0227; H05B 37/0272; H05B 37/0218

(57) ABSTRACT

The present invention provides a method for minimizing a ripple current and turning the light emitting diode (LED) OFF rapidly in order to maximize the efficiency of a light emitting diode array. To achieve this, a set of dual drain field effect transistor circuit is included with a light emitting diode array and a filter capacitor, wherein the LED current and the filter capacitor current are interrupted through a common source i.e. the dual drain field effect transistor (or two equivalent FETs). This turns the LEDs off nearly instantly, turns a switching power converter off and preserves the ripple filtering effects of the filter capacitor.

### CROSS-REFERENCE TO RELATED APPLICATION

This application is a continuation-in-part of U.S. application Ser. No. 14/147,607 filed on Jan. 6, 2014, which is hereby incorporated by reference in its entirety.

### FIELD OF THE INVENTION

The present application relates to an apparatus for providing intelligence to a lighting system, and more particularly, to an apparatus for providing ALS strobe architecture for a lighting system.

### BACKGROUND

Over the years lighting system technology has advanced manifold. Energy conservation in lighting systems plays a vital role in generating effective illumination, besides being cost effective. Without compromising on ambience, visual comforts and aesthetics, it is also a requisite to integrate light system-designs with economics and environment.

Of late, different light sources have come up and been replaced by improved variants. Prominent among them have been incandescent lamps, gas-discharge bulbs, fluorescent lamps and light emitting diodes, to name a few. Certain factors like life-span of the light source, light distribution, light diffusion, sensitivity to temperature and humidity and operational cost are crucial in determining reliability of lighting systems.

Light emitting diodes lamps are more energy efficient as compared to other conventional source of lighting. A trend of replacing conventional lamp with the LED retrofit lamp is getting more and more popular.

Since energy conservation and management of electrical power is a growing concern with regard to both cost and environmental impact, the LED retrofit lamp technology therefore requires further improvement. Therefore, a system is required that enables the user to harvest substantial portion of energy from the existing LED lamp circuit and to provide intelligence built-in features for controlling the wastage of energy.

Environment responsive intelligence in LED retrofits may further enhance energy management by drastically reducing wasteful consumption. Public spaces can be monitored on the basis of specific environmental stimuli like occupancy and time-clocks, so as to yield optimum light. This can bring significant improvement in user comfort and energy savings in commercial and industrial applications.

### BRIEF DESCRIPTION OF THE DRAWINGS

The preferred embodiment of the invention will hereinafter be described in conjunction with the appended drawings provided to illustrate and not to limit the scope of the invention, wherein like designation denote like element and in which:

FIG. 1 is a schematic representation of the intelligent lighting system, in accordance with an embodiment of the present invention.

FIG. 2 illustrates the component of a controlling unit with built-in intelligence feature, in accordance with an embodiment of the present invention.

FIG. 3 is a circuit diagram of an intelligence lighting system in accordance with an embodiment of the present invention.

FIG. 4 illustrates a flow diagram representing the process flow of the working of an intelligent lighting system, in accordance with an embodiment of the present invention.

FIG. 5A illustrates a schematic representation of a LED Lighting system with a controller and a power converter to control the forwarding voltage to LEDs.

FIG. 5B shows the output waveform of the buck converter operating with the FET.

FIG. 5C illustrates a graph signifying the exponential current decay across the LED array with a time constant (τ).

FIG. 6A illustrates another representation of a LED lighting system with a controlling unit and a field effect transistor to control LED lighting.

FIG. 6B illustrates a schematic representation of another power architecture of LED lighting system with a controlling unit and a FET.

FIG. 7A illustrates a power conversion architecture in a LED lighting system to be used with ambient light sensor in accordance with an embodiment of the present invention.

FIG. 7B illustrates a power conversion architecture having low-end FETs in a LED lighting system to be used with ambient light sensor in accordance with an embodiment of the present invention.

FIG. 8 is a schematic representation of a power architecture for turning off the LEDs rapidly in a LED lighting system in accordance with an embodiment of the present invention.

FIG. 9 illustrates a LED lighting system with built-in intelligence to dim off lamp while keeping the lamp monitoring sensors and modem awake, in accordance with an embodiment of the present invention.

### BRIEF SUMMARY OF THE INVENTION

In a first aspect of the present invention, a LED lighting system with built-in intelligence is provided. The LED lighting system comprising a power converter to control the dimming of an LED array in response to feedback received from one or more monitoring sensors; a bridge rectifier to convert AC power coming from an external source to DC power for the power converter and; a series combination of a first capacitor and a DIAC connected parallel at the input terminal of the bridge rectifier; a second capacitor connected in parallel to the series combination of the first capacitor and the DIAC, said second capacitor is present between the external source and the series combination of the first capacitor and the DIAC. The controlling unit dims off the LED array on receiving instructions from said one or more monitoring sensor while the LED lighting system draws a little power. The first capacitor has a rating of 50-300 nF and the second capacitor has a rating of 1-10 nF. The power converter may be any of a buck/boost converter, a flyback converter or single-ended primary-inductor converter (SEPIC), a linear converter or a resonant converter.

In another aspect of the present invention, a LED lighting system with built-in intelligence is provided. The LED lighting system comprising: an LED array having one or more light emitting diodes; a power converter for providing power to the LED array in a normal operating state; a capacitor placed in parallel with the LED array to prevent ripple current from flowing to the LED array; a controller to receive a request from an ambient light sensor for measuring ambient light parameters, said controller on receiving the request generate a strobe signal; a first field effect transistor connected in series at positive end of the LED array and a second field effect transistor connected in series with the capacitor; wherein when a request from the ambient light sensor is made, the microcontroller sends strobe signal to the first field effect transistor and the second field effect transistor to turn off the power supply to the LED array and the capacitor. The LED lighting system further comprising a third field effect transistor connected in series with a second end of the LED array which get asserted by the strobe signal. The LED lighting system further comprising a fourth field effect transistor connected in series with a second end of the capacitor which get asserted by the strobe signal. The strobe signal is generated for activating the ambient light sensing state to monitor the ambient light condition by switching off the LED array. The power converter for converting the DC voltage into a constant current output is a buck convert, a flyback converter or single-ended primary-inductor converter (SEPIC), a linear converter or a resonant converter.

In another aspect of the present invention, a LED lighting system with built-in intelligence is provided. The LED lighting system comprising an LED array having one or more light emitting diodes and a large capacitor placed in parallel to the LED array; a power converter to supply power to the LED array through an inductor and a charge pump circuit, said charge pump circuit comprises a first capacitor and a second capacitor, a filed effect transistor having a source terminal connected to the power converter for receiving the constant current output, a drain terminal connected to the LED array and a gate terminal connected to the charge pump circuit at a node present between the first capacitor and the second capacitor; a voltage source connected to the node between the first capacitor and the second capacitor; a second FET connected in parallel to the second capacitor to receive a strobe signal generated by a controller on a request made by an ambient light sensor for measuring ambient light parameters; wherein during the normal operating mode, the drain gate of the first FET is at higher voltage than the source voltage and the LED array is in ON state and when the request is made by ambient light sensor the controller turn ON the second FET which pulls down the voltage at the gate terminal of the first FET which turns off the LED array. The large capacitor placed in parallel to the LED array has a rating of 10 uF to 100 uF. The first field effect transistor remains open during normal operating state and the LED array remain ON. The power is a buck convert, a flyback converter or single-ended primary-inductor converter (SEPIC), a linear converter or a resonant converter. The first FET and the second FET is a MOSFET. The power converter further comprises a means that can be asserted by a pulse width modulating signal to switch off the supply to the LED array. The strobe signal is of 50 us to 150 us.

### DETAILED DESCRIPTION OF THE EMBODIMENTS

In the following detailed description of embodiments of the invention, numerous specific details are set forth in order to provide a thorough understanding of the embodiment of invention. However, it will be obvious to a person skilled in art that the embodiments of invention may be practiced with or without these specific details. In other instances, well known methods, procedures and components have not been described in detail so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

The present invention provides a lighting system with built-in intelligence feature to allow it to dim itself in response to autonomous or external stimuli and to harvest power for the internal and external circuit. The lighting system comprises a LED lamp driven by a ballast and a controlling unit that imparts built-in intelligence system to the LED lamp. The circuit of the lighting system comprises a LED lamp having an array of light emitting diodes, wherein one set of the series diodes is left on and the power is harvested, in parallel from the set of series diode. A field effect transistor (FET) is wired in parallel with a portion of the light emitting diode array; the field effect transistor controls the forward voltage of the LED lamp. The Field Effect Transistor, when turned off, exposes the full light emitting diode array and the maximum forward voltage to the LED lamp. Similarly, field effect transistor, when turned on, short circuits many of the light emitting diodes and reduces the forward voltage and the power drawn from the ballast.

The embodiments of the present invention comprise a controlling apparatus with an 8 bit micro controller, a power conditioning circuitry such as a Low Dropout Regulator (LDO) to regulate power to the peripheral interface controller (Microcontroller unit) and an external interface.

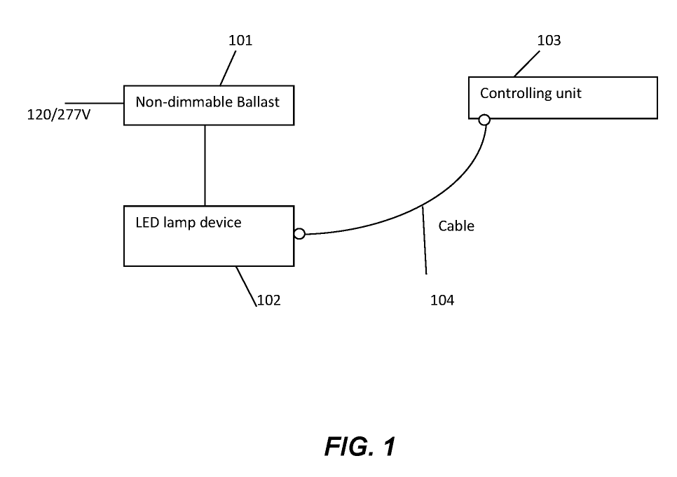

FIG. 1 is a schematic representation of the intelligent lighting system, in accordance with an embodiment of the present invention. The lighting system comprises a non-dimmable ballast 101, a LED lamp 102 and a controlling unit 103 with built-in intelligence features. The non-dimmable ballast 101 regulates the current to the LED lamp 102 and provides sufficient voltage to start the LED lamp 102. At the start-up of the LED lamp 102, the non-dimmable ballast 101 supplies high voltage to establish an arc. Once the arc is established, the non-dimmable ballast 101 quickly reduces the voltage and regulates the electric current to produce a steady light output. The controlling unit 103 receives power from the LED lamp 102 through a micro USB cable 104 and harvests the power to drive the circuitry of the controlling unit 103 and small power driven devices or sensors connected to the controlling unit 103. The power is harvested in range of 5V/100 mA sufficient to drive the circuit electronics of the controlling unit 103.

In an embodiment of the invention, the controlling unit 103 may enable additional functionality to the LED lamp 102 such as power reduction for thermal management, top trimming at factory via the controlling unit 103, and top trimming in field via circuit switching or other stimulus. Furthermore, a single controlling unit 103 can control a plurality of LED lamps 102. The lamp may be circuit switched via the controlling unit 103, in addition to being locally controlled. The controlling unit 103 further comprises a means for sensing the ambient parameters such as an occupancy sensor or a photo sensor. The controlling unit 103 further comprises a modem that allows control at a higher level or may comprise of a combination of the sensors and the modem.

The controlling unit 103 is further connected to an external monitoring device such as an occupancy sensor or a photo sensor. The controlling unit 103 receives the input from the monitoring device and controls the dimming of the LED lamp 102. The occupancy sensor is a lighting control device that detects occupancy of a space by people and turns the lights on or off automatically, using infrared or ultrasonic technology. The energy saved by the occupancy sensors provides automatic control over lighting and complies with the building's codes.

In an embodiment of the present invention the controlling unit 103 harvests a small amount of DC power from the constant current supplied by the non-dimmable ballast 101. The harvested power is then used to drive the external and internal electronics of the controlling unit 103 as well as the monitoring device. Thus, there is no need of providing extra power to the controlling unit 103.

In another aspect of the present invention, the controlling unit 103 further comprises a means to control the forward voltage to the LED lamp 102 that enables the dimming of LED lamp 102 in response to external stimuli.

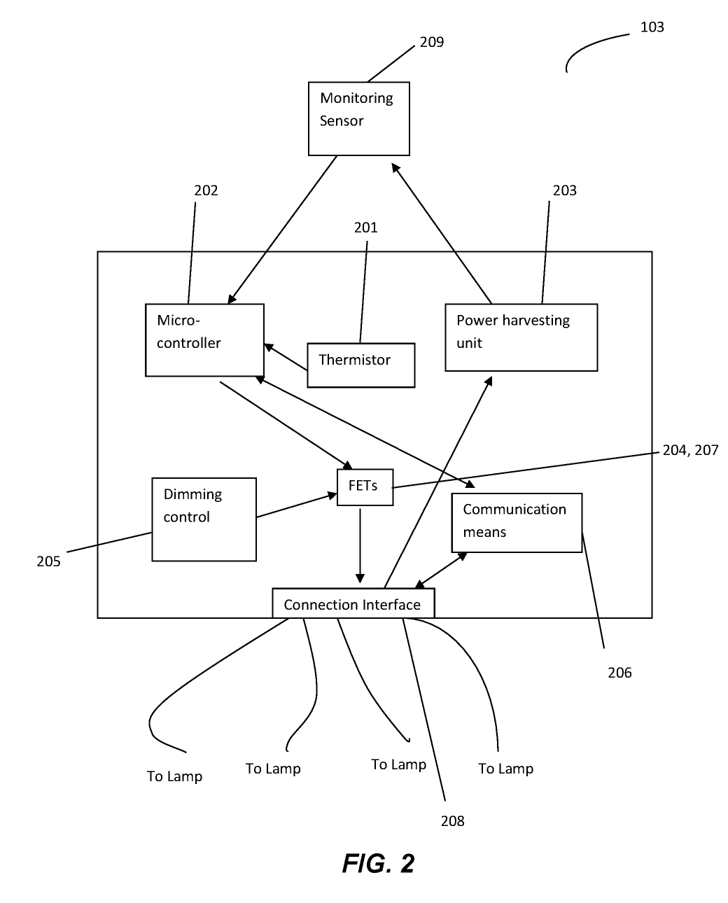

FIG. 2 illustrates the component of a controlling unit 103 with built-in intelligence feature, in accordance with an embodiment of the present invention. The controlling unit 103 comprises of a thermistor 201 that serves as a temperature sensing input, an 8 bit micro controller 202, a field effect transistors 204 and 207, a power harvesting means 203, a dimming control means 205, a communication means 206, a connection interface 208, a monitoring sensor 209 to sense the lighting parameters. The monitoring sensor 209 collects the ambient information and calculates the required light intensity in the monitored area and feed its input to the micro-controller 202 in the controlling unit 103. The controlling unit 103 is connected to a plurality of the LED lamp 102 through a USB interface 208. The wiring required for connection is class-2 type, thus eliminating the need of a skilled person. A cable 104 is required for transferring information to and form the controlling unit 103 to the LED lamp 102 and also provides a mean for transferring power from one of the LED array 308 in the LED lamp 102 to the controlling unit 103.

The controlling unit 103 contains a power harvesting means 203 that harvest the power simultaneously from the LED lamp 102. The LED lamp 102 contains a series of LED array 308 that always remains in an ON position; a circuit is extended parallel from the LED strings from where power is drawn to the power harvesting means 203 in the controlling unit 103 using the micro USB cable 104 and the connection interface 208. The power harvesting means 203 in the controlling unit 103 stores the power and uses it for driving the internal components of the controlling unit 103 as well as for feeding power to the monitoring sensors 209. The use of power harvesting means 203 eliminates the need of extra source of power for driving the controlling unit 103.

In an embodiment of the present invention, the connection interface 208 is connected to the LED lamp 102 through the cable 104 which is class 2 type. The cable 104 comprises a micro USB cable, RJ11, RJ14, RJ21, RJ45, RJ48 or other known class 2 type cables.

The field effect transistors 204 and 207 present in the controlling unit 103 control the forward voltage to the LED lamp 102. The field effect transistors 204 and 207 are circuited in parallel with the portion of LED array 308. Turning the field effect transistors 204 and 207 off exposes the full LED array 308 and thus maximum forward voltage to the LED lamp 102. On turning the field effect transistors 204 and 207 ON, many of the LEDs get short circuits thereby reducing the forward voltage and power drawn from non-dimmable ballast 101.

The dimming control 205 in the controlling unit 103 controls the illumination intensity of LED lamp 102. The microcontroller 202 receives the input from monitoring sensors 209 and on receiving the input instructs the dimming control 205 to control the output to the LED lamp 102.

The dimming control 205 then sends instruction to the field effect transistors 204 and 207 to reduce the forward voltage to LED lamp 102.

In another embodiment of the present invention, the forward voltage to the LED lamp 102 is controlled by placing a series of FET connected in parallel to the LED array. On receiving an input from the dimming control 205, the microcontroller 202 decides the number of FETs to remain in ON position. Each FET in the series is having an extra LED connected to the series. Depending on the instructions received from the microcontroller 202, the FETs in series turn ON additional LEDs thus regulating the forward voltage to the LED lamp 102.

In an embodiment of the present invention, the lighting system further comprises a thermistor 201 that monitors the temperature of the LED lamp circuit 102. The thermistor 201 may be present in the LED lamp 102 or it may be in the controlling unit 103. In case of overheating, the thermistor 201 senses the temperature and sends the feedback to the microcontroller 202. The microcontroller 202 then instructs the field effect transistors 204 and 207 to regulate the forward voltage in the event of the overheating of circuit.

In another embodiment of the present invention the controlling unit 103 further comprises a communication means 206 such as a modem or a radio frequency means. The communication means 206 is connected to the microcontroller 202. The user can send his instructions to the microcontroller 202 using the communication means 206.

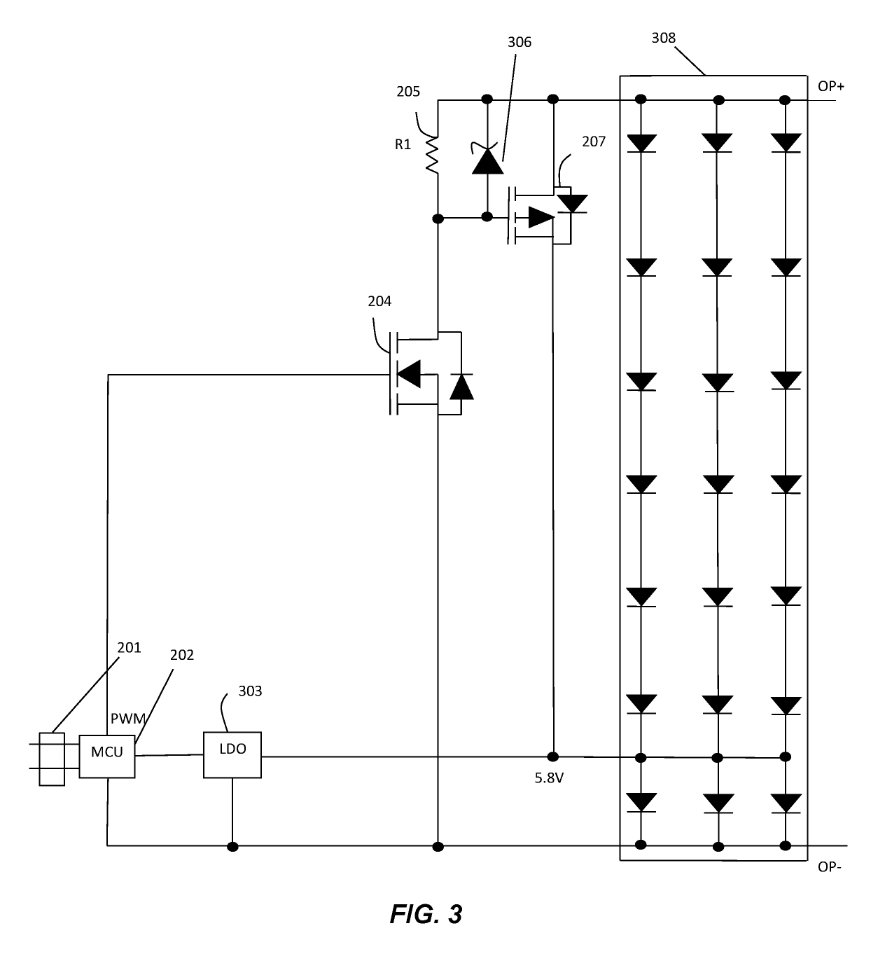

FIG. 3 is a circuit diagram of a controlling unit 103 in accordance with an embodiment of the present invention. Referring to FIG. 3, the schematic arrangement of the controlling unit 103 shows that the inputs in the form of temperature sensing input from the thermistor 201 and dimming control input from the monitoring sensors 209 are being fed to the microcontroller 202 that creates a pulse width modulated signal at a frequency of approximately 1 kHz to field effect transistors 204 and 207 that reduces the string length and lamp power in response to being asserted. The thermistor 201 serves the purpose of sending an input to the microcontroller 202 that enables the field effect transistors 204 and 207 to reduce power level in response to overheating and an external dimming signal. A low dropout regulator 303 functions as a power conditioning circuitry to regulate power to the monitoring sensor 209, the controlling unit 103 and the LED lamp 102. The low dropout regulator 303 operates with a very small input-output differential voltage and includes a lower minimum operating voltage, higher efficiency operation and lower heat dissipation. The Zener diode 306 allows current to flow in the forward direction and also permits current to flow in the reverse direction when the voltage is above a certain value. The field effect transistors 204 and 207 have the ability to control the forward voltage of the LED lamp 102 that is wired in parallel with a portion of the LED array 308. When the field effect transistors 204 and 207 are turned OFF, it exposes the full LED array 308 and the maximum forward voltage to the ballast and turning the field effect transistors 204 and 207 ON short circuits many of the light emitting diodes, which reduces the forward voltage and the power drawn from the ballast. The light emitting diode array 308 is left ON and power is harvested in parallel from the array for the internal microcontroller 202 and an external lamp of up to 5V/100 mA.

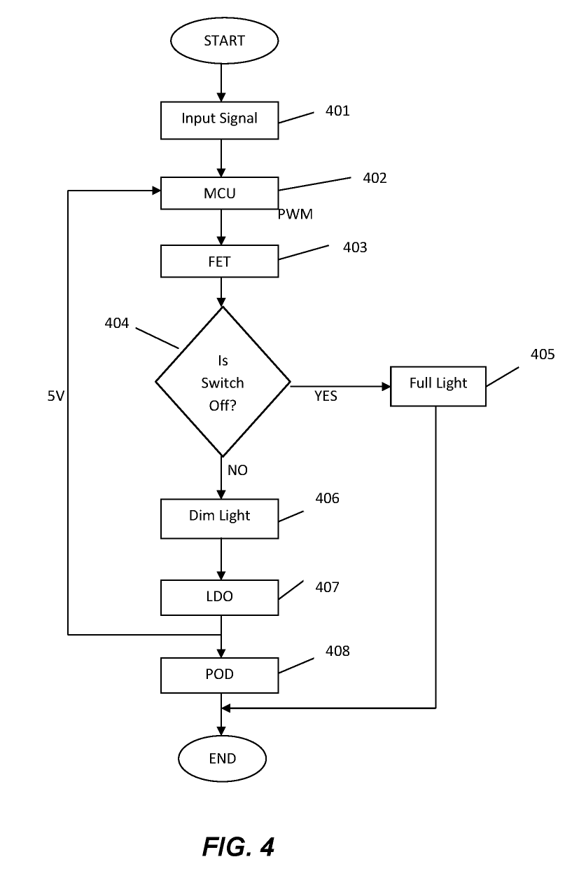

FIG. 4 illustrates a flow diagram representing the working of the lamp circuit in accordance with an embodiment of the present invention. In step 401 when an input signal is fed to the microcontroller unit 202 from the thermistor 201, a pulse width modulated signal is generated in step 402. The pulse width modulated signal generated in step 402 is then relayed to the field effect transistors 204 and 207 in step 403. It will further check in step 404 whether the field effect transistors 204 and 207 are switched ON or switched OFF. When the field effect transistors 204 and 207 are switched OFF, it exposes the full light emitting diode array 308 and the maximum forward voltage to the non-dimmable ballast 101 as shown in step 405. When the field effect transistors 204 and 207 are turned ON, it short circuits many of the light emitting diodes present in the light emitting diode array 308 and reduces the forward voltage and the power drawn from the non-dimmable ballast 101 in step 406. The dimmed light is then relayed to the low dropout regulator 303. The low dropout regulator 303 regulates the power to a peripheral interface controller and external interface for microcontroller 202 in step 407 and LED lamp 102 in step 408. Hence, the lighting system has sufficient built in intelligence to allow it to dim itself in response to autonomous or external stimuli.

In an embodiment, the present invention provides a LED lighting system with a controlling unit connected to an ambient light sensor (ALS). The ambient light sensor (ALS) can be disposed at different positions around the LED lighting system such as inward or outward of the optical cavity. The ambient light sensor (ALS) is designed to measure the ambient light coming back into the lamp when the LEDs are in OFF state. When the intensity of light is to be measured in ambient light sensing state, the LED lighting system are turned OFF for a small interval of time such that flickering of LEDs is not perceivable with human eyes. This can be done by controlling the power to the LEDs in the LED lighting system.

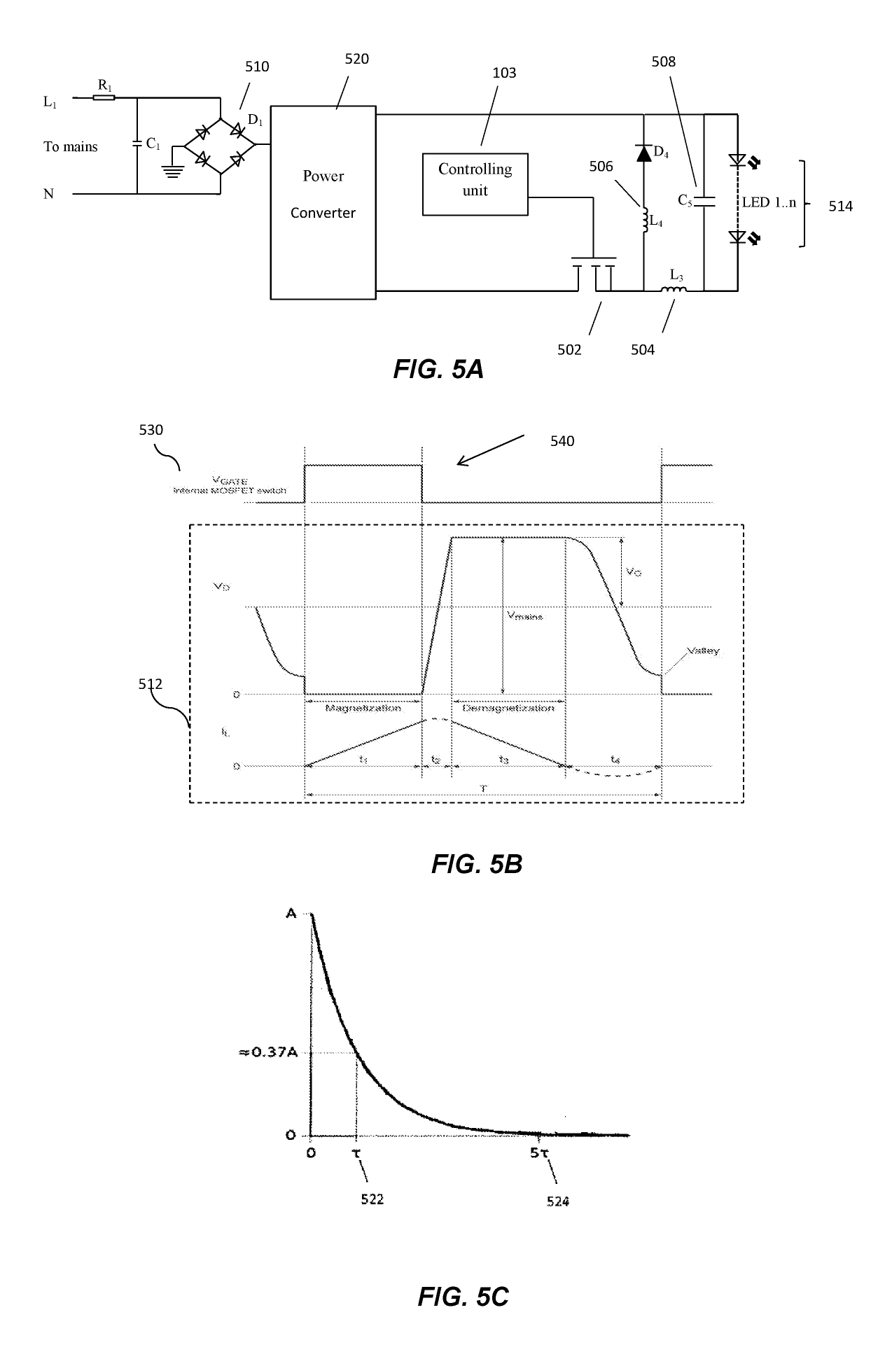

FIG. 5A illustrates a schematic representation of a LED Lighting system with a controller and a power converter to control the forwarding voltage to LEDs. The LED lighting system comprises a bridge rectifier 510 that converts an alternating current (AC) coming from mains to a direct current (DC) to drive the LED array 514. The power converter 520 converts a constant voltage input at the bridge rectifier 510 to a constant current output. A controlling unit 103 receives input from an ambient light sensor and on receiving the feedback controls the current flowing through the LED array 514 by switching a field effect transistor (FET) 502. In normal operating state, when the FET 502 is in ON state, the current flowing in the LED lighting system discharges across the LED array 514 and allows an inductor 504 to be charged simultaneously. When the FET 502 is OFF, the inductor 504 discharges through a second inductor 506 and a diode resulting into discharging of the inductor 504.

In order to prevent ripple current entering into the LED array, a filter capacitor 508 is placed in parallel to the LED array 514, which filters the DC rippled voltage into the smooth DC output voltage to drive the LED array 514. The filter capacitor 508 is sized large enough to operate on both the switching frequency of FET 502 as well as the frequency of line input.

The filter capacitor 508 and the LED array 514 have a discharging time constant (τ) that defines an exponential current decay of the filter capacitor 508 across the LED array 514. The ALS sampling event is affected by long time constant between the filter capacitor and LEDs. If the LEDs do not turn completely OFF within the required short amount of time the residual LED light washes out ambient light that leads to prevent proper ALS detection. On the other hand, to ensure the LEDs are OFF on a PWM cycle requires waiting too long causing a visual glitch in the LED output. In order to shut the LEDs off rapidly with a minimized ripple, various mechanisms can be implemented such as the filter capacitor could be reduced in size to reduce the time constant of current decay to the LEDs; the LED string itself could be interrupted with a FET and the like. However, these mechanisms do not provide an optimal solution for minimizing ripple current and turning ON and OFF the LED array rapidly so that the visual glitches do not appear.

During the operation, when a pulse width modulating signal is de-asserted, switching of the FET 502 stops, and capacitor 508 starts discharging through the LED array. Time constant (τ) to the capacitor 508 through LEDs is chosen to be much larger than the switching frequency of FET 502 to minimize current ripple. For instance, for 100 kHz, an increase of 10-40 ms is typical resulting in a current ripple of 5%. Unless PWM frequency is greater than 5τ, LEDs will never turn off. The time constant (τ) is desired to be five times of the switching frequency of FET 502 in order to adequately filter ripple.

FIG. 5B shows the output waveform of the buck converter operating with the FET. When the FET 502 is turned ON, the current flows across the LED array 514 and the inductor 504. Once the FET 502 turns off, the inductor 504 discharges through the LED array 514. Referring to FIG. 5B, a waveform 530 shows output during switching cycle of the FET and a waveform 540 denotes charging and discharging of the inductor 504. When the FET 502 turns on, magnetization occurs that causes the charging of the inductor 504 for a time duration ti shown in the waveform 512. When the FET 502 turns OFF, demagnetization occurs that leads discharging of the inductor 504 for a time duration t3 shown in the waveform 540.

FIG. 5C illustrates a graph signifying the exponential current decay across the LED array with a time constant (τ). At the time constant (τ) 522, the filter capacitor 508 contains remaining charge of approximately 0.37 ampere that is 37% of peak LED current. The current-time characteristic of exponential current decay also shows that the LED array 514 turns completely OFF after 5τ 524.

While working with a LED array and a capacitor, to filter a 40 kHz switching frequency having time period of 25 us, the time constant (τ) is desired to be greater than 125 us in order to get 10% ripple. Thus, the 40 kHz switching frequency requires a filter capacitor of approximately 470 nf. Similarly, to filter a 60 Hz line input with a rectified period of 8.3 ms, the time constant (τ) is desired to be greater than 41 ms in order to get 10% ripple. Thus, the 60 Hz line frequency requires a filter capacitor of approximately 150 uf.

For ambient light sensor to work, the requirement of the power system present in the lighting system is to be able to turn off the LEDs for a period of approximately 100 us, letting the ambient light sensor (ALS) stabilize and strobe it and then turn the LEDs on. One of the methods is to interrupt the LEDs array with a FET present either at the high end of LED arrays or at the low end of LED array. The FET present at the end of LED arrays can be asserted by a microcontroller on receiving feedback from the ambient light sensor. The FET will then stop supply of power to LED array and the LEDs get turn off for the desired duration of time. However, the power converter will continue to charge the capacitor to V_{Boost}.

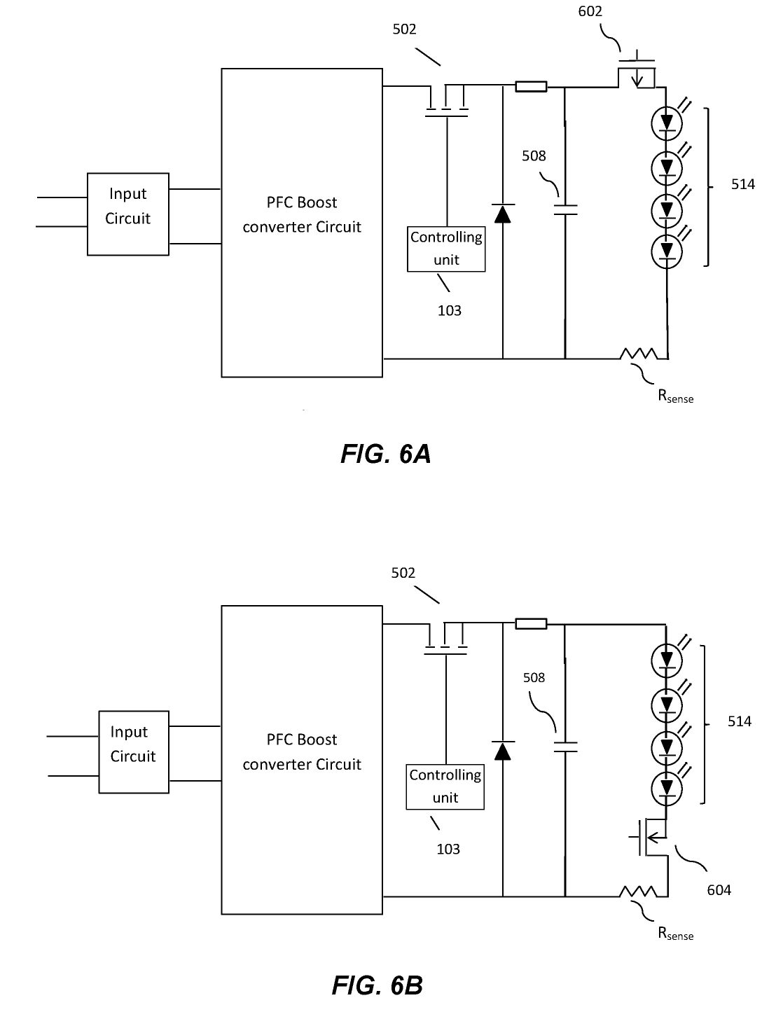

FIG. 6A illustrates another representation of a LED lighting system with a controlling unit and a field effect transistor to control LED lighting. The current flowing through the filter capacitor 508 and the LED array 514 can be interrupted using a series connected p-channel field effect transistor (FET) 602 at the first end of the LED array 514.

FIG. 6B illustrates a schematic representation of another power architecture of LED lighting system with a controlling unit and a FET. The current flowing through the filter capacitor 508 and the LED array 514 can be interrupted using a series connected n-channel field effect transistor (FET) 604 at the second end of the LED array 514.

The LED lighting system illustrated in FIG. 6A and 6B interrupt the LED current in order to shut the LEDs rapidly OFF. However, in these implementations, when the FET is ON, the flowing power converter current result into glowing of the LED array and causes the filter capacitor to be charged. When the FET turns OFF, the LEDs also turn OFF rapidly; but the power converter current will continue to charge the filter capacitor up to a peak voltage V_{Boost}. Further, when the FET is turned back ON, overcharging of the filter capacitor produces a large spike current to flow through the LED array resulting LED damage. For these types of implementation, the capacitor 508 should be of large rating.

When the ambient light sensor (ALS) has collected data, the LED lighting system will resume to normal state and the high end FET or low end FET is turned back on, the capacitor starts discharging resulting in a large surge of current through the LEDs. To avoid the flow of surge current through LEDs, a set of FETs is required that disconnect both the capacitor as well as LED array from the power converter.

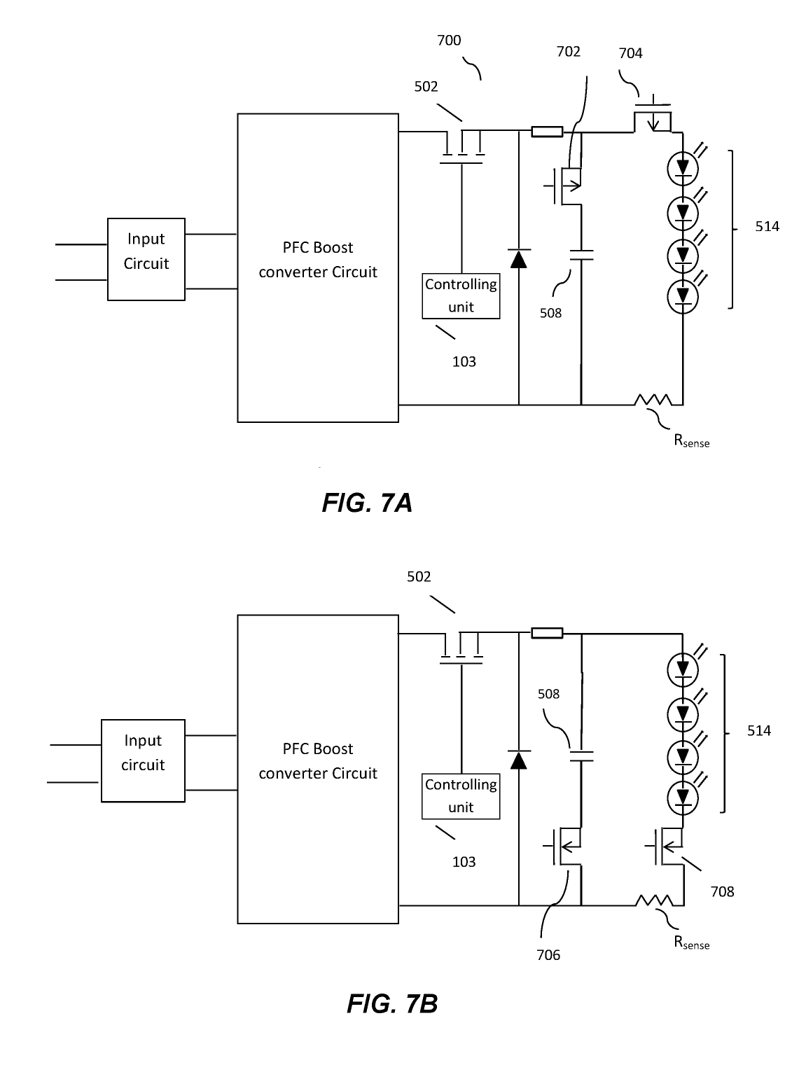

FIG. 7A illustrates a power conversion architecture 700 in a LED lighting system to be used with ambient light sensor in accordance with an embodiment of the present invention. The LED lighting system comprises an Input circuit that receives power from an external source to convert AC input waveform to DC volt waveform. The FET 502 can be de-asserted by the controlling unit 103 through a pulse width modulating signal. The FET 502 controls the forward voltage to the LED array 514 and the capacitor 508 placed in parallel to the LED array. The power architecture further comprises a first p-channel FET 704 at the high end of LED array and a second p-channel FET 702 before the capacitor 508. When an ALS sampling event is desired, the first p-channel FET 704 and the second p-channel FET 702 are turned off by a strobe generated by a microcontroller in response to request for sensing ambient light parameters by ambient light sensors. The first p-channel FET 704 and the second p-channel FET 702 are turned off by same signal, such that the power coming from FET 502 will neither conducted to capacitor 508 nor to LED array 514. This prevents the capacitor 508 to charge to VBoost. When the ambient light sensing event has occurred, the microcontroller turns on the first p-channel FET 704 and the second p-channel FET 702 and the LEDs turn ON. The strobe is generated for a short interval of time such that LEDs turn off without showing flicker to human eye. In one implementation, strobe is of 100 us duration.

FIG. 7B illustrates a power conversion architecture having low-end FETs in a LED lighting system to be used with ambient light sensor in accordance with an embodiment of the present invention. The current flowing through the filter capacitor 508 and the LED array 514 can be interrupted using a first n-channel field effect transistor (FET) 708 placed at low end of the LED array and a second n-channel field effect transistor 706 present at a second end of the filter capacitor 508 as shown in FIG. 7B. When an ALS sampling event is desired the first n-channel FET 708 and the second n-channel FET 706 can be controlled by a microcontroller. The microcontroller, on receiving request for the ALS sampling event, transmits a ground reference strobe signal to first n-channel field effect transistor 708 and the second n-channel field effect transistor 706. The second n-channel field effect transistor (FET) 706, connected across the second end of the filter capacitor 508 and the first n-channel field effect transistor 708 turns OFF by the microcontroller, the filter capacitor 508 and the LED array 514 get disconnected from the power converter circuit at the same time causing no current flow through the filter capacitor 508. Thus, the filter capacitor 508 does not store any charge during ambient light sensing event. When the ambient light sensing event is over, the filter capacitor 508 and the LED array 514 get connected to the power converter circuit at the same time and the current flows through the filter capacitor 508 and the LED array 514.

In another embodiment of the present invention, the power architecture can be a buck/boost converter, a flyback converter, a SEPIC converter, a linear converter or a resonant converter.

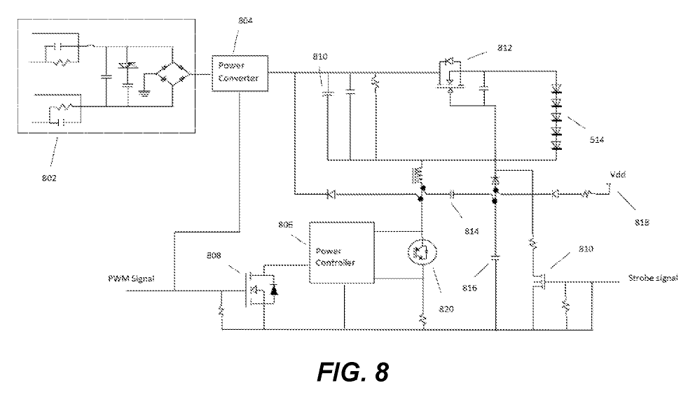

FIG. 8 is a schematic representation of a power architecture for turning off the LEDs rapidly in a LED lighting system in accordance with an embodiment of the present invention. The LED lighting system comprises an input circuit 802 for receiving power from an external source and converting the power into DC waveform. The DC power is then supplied to a power converter 804 and power controller 806 and to the LED array 514. The power controller 806 is controlled by a PWM signal that can be generated in response to a controlling unit. The controlling unit generates a PWM signals in response to a plurality of monitoring sensors. This PWM signal controls the switching state of a FET 808 which is present in the power converter 806. When the FET 808 is asserted, it prevents the current from flowing to power controller 806.

In normal operating state, the FET 808 is in conducting state and the power controller 806 receives continuous power supply. The power controller 806 operates the LED array 514 at high voltage with a large filtering capacitor 810 to minimize ripple current. When an ambient light sensing event is desired, a microcontroller dims the power controller 806 to zero to stop it from switching by driving a pulse width modulating signal high. Simultaneously it asserts a 100 us strobe signal for 100 us through a first FET 810. The first FET 810 conducts the current to the gate terminal of a second FET 812 which opens up the second FET 812 and turns the LEDs off almost instantly without requiring the large capacitor to discharge. The 100 us strobe signal is ground references and voltage translation from the 100 us strobe signal is made to the second FET through a charge pump circuit operating off the switching power supply. The charge pump circuit comprises a first capacitor 814 and a second capacitor 816.

In another embodiment of the present invention, the power architecture performed in two states: normal operating state and ALS sampling event. During the normal operation Vdd 818 is charged to a few volts. When the FET 820 present in the power converter 806 turns off, the left side of the first capacitor 814 rises to LED operating voltage, which pulls the right side of the first capacitor 814 to LED operating voltage+Vdd. The LED operating voltage+Vdd is conducted through a diode and charges the gate of second FET 812. At this time, the source of the second FET 812 stays at LED operating voltage, which turns ON the LED 514.

During the ALS sampling event, a strobe signal is generated by the microcontroller which turns ON the first FET 810, which in turn pulls down the gate of second FET 812 and turns the second FET 812 off. When the ALS sampling event is over, the gate voltage of the second FET 812 quickly recovers and turns the second FET 812 On, which turns ON the LED array 514.

During the dimming off state, only the sensors and modems are drawing power and hence the LED lighting system draws a little standby power. In one embodiment, the present invention provides an input circuit for the LED lighting system designed in such a manner that the LED lighting system and the ballast to which the LED lighting system is connected remains stable during the low power.

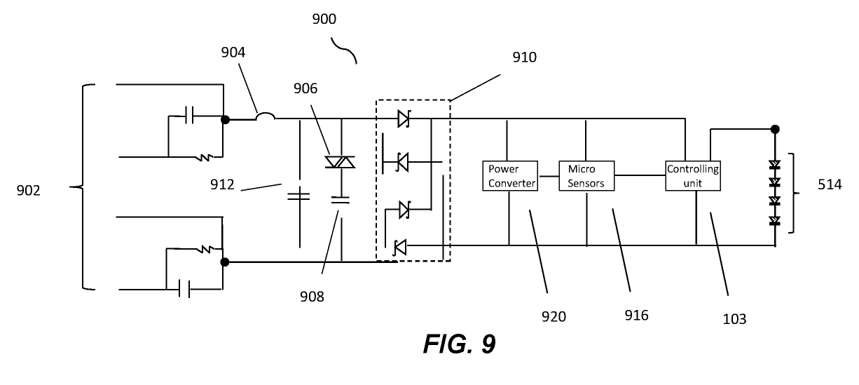

FIG. 9 illustrates a LED lighting system with built-in intelligence to dim off lamp while keeping the lamp monitoring sensors and modem awake, in accordance with an embodiment of the present invention. The LED lighting system 900 comprises an input terminal 902 that receives power supply from an external source. The external source can be a line voltage source, a magnetic ballast, a low frequency electronic ballast or a high frequency ballast. A bridge rectifier 910 receives the AC voltage coming from the external source and converts into DC voltage. A fuse 904 is provided at the input terminal coming from the external source. After the fuse 904 a first capacitor 912 is placed in parallel to the input terminal 902. The first capacitor 912 has a rating of 1 to 10 nF. A series combination of a second capacitor 908 and a DIAC 906 is connected in parallel to the first capacitor 912 and the bridge rectifier 910. The second capacitor 908 is a large capacitor with a rating of 50 μF to 200 μF. The DC voltage generated by the bridge rectifier 910 is then transferred further to a power converter 920 that converts constant voltage input coming from the bridge rectifier 910 into a constant current output. The LED lighting system 900 is controlled by feedback from a plurality of micro sensors 916 that monitors required ambient lighting conditions. A controlling unit 103 controls the dimming off the LED lighting system 900 on receiving feedback from the plurality of microsensors 916. The controlling unit 103 controls the forward voltage to a LED array 514 having one or more light emitting diodes, thus enable the dimming off the LED lighting system.

In an embodiment of present invention, the LED lighting system 900 can be operated with different external sources such as, but not limited to, 120/277V line input, 60 Hz magnetic ballast, high frequency electronic ballast having frequency 40-60 kHz and low frequency electronic ballast having frequency 20-25 kHz.

In an embodiment of present invention, the LED lighting system 900 is compatible to dim off the LED array 514 while keeping the plurality of monitoring sensors and the communication means 206 awake, satisfying the ballast operational requirement and drawing as little standby power or “Vampire power” as possible.

When the external source is a line voltage, the power coming to the input terminals 902 is a constant voltage source. On receiving feedback from the plurality of microsensors the controlling unit 103 dims off the power to the LED array 514 and only the plurality of micro sensors 916 and the communication units are using the current power. Since, the external source is a constant voltage source therefore; in this case, LED lighting system can draw as little current as required and thus minimizing the vampire power. In this case, the power will not flow from the first capacitor 912 and the second capacitor 908, and power directly passes through the bridge rectifier 910 where it is rectified and passes through the power converter 920.

In an embodiment of the present invention the LED lighting system 900 can be operated with a magnetic ballast. During the magnetic ballast operation, the input power is supplied to the rectifier circuit directly without passing through the first capacitor 912 and the large second capacitor 908. The rectified power is fed to the LED array through the switching converters.

In another embodiment of the present invention the LED lighting system 900 is compatible to operate with a high frequency electronic ballast in a dim-off condition. In case of the high frequency electronic ballast, current passes through the first capacitor 912 in order to convert ballast constant current input to 100V constant voltage output. Further, the 100V constant voltage is rectified using rectifier circuit and supplied to the LED array through the switching power converter.

In another embodiment of the present invention the LED lighting system 900 can be operated with a low frequency electronic ballast. During low frequency electronic ballast operation, the current passing the capacitor 912 is converted into a very high voltage causing DIAC 906 to close. The remaining current of the DIAC is being passed through the larger second capacitor 908 in order to create a constant voltage of 100V. Then, the 100V constant voltage is rectified and passes through the switching power supplies to glow the LED array 514.

The invention finds lightening application in various areas like indoor light, outdoor light and various other decoration or ornamental light, power reduction for thermal management. The lighting system has ability to harvest a small amount of DC power from the constant current AC ballast to drive internal and external electronics.

We claim:

1. An ambient light sensing strobe architecture to be used in a light emitting diode (LED) lighting system, comprising:
an LED array having one or more light emitting diodes;
a capacitor placed in parallel with the LED array to prevent ripple current from flowing to the LED array;
a controller to receive a request from an ambient light sensor for measuring ambient light parameters, said controller on receiving the request generates a strobe signal;
a first field effect transistor (EFT) connected in series at one end of the LED array;
wherein when a request from the ambient light sensor is made, the microcontroller sends a strobe signal to the first field effect transistor to turn off the power supply to the LED array.

2. The LED lighting system of claim 1, further comprising a second field effect transistor connected in series with the capacitor.

3. The LED lighting system of claim 1, wherein the first field effect transistor is placed at the positive end of the LED array or at the negative end of the LED array.

4. The LED lighting system of claim 2, wherein the second field effect transistor is placed at either end of the capacitor.

5. The LED lighting system of claim 1, wherein the strobe signal is generated to activate an ambient light sensing state to monitor the ambient light condition by switching off the LED array.

6. A LED lighting system with built-in intelligence comprising:
a LED array having one or more light emitting diodes;
a capacitor placed in parallel to the LED array;
a power converter to supply power to the LED array through an inductor and a charge pump circuit, said charge pump circuit comprises a first capacitor and a second capacitor;
a field effect transistor having a source terminal connected to the power converter for receiving the constant current output, a drain terminal connected to the LED array and a gate terminal connected to the charge pump circuit at a node present between the first capacitor and the second capacitor;
a voltage source connected to the node between the first capacitor and the second capacitor;
a second field effect transistor connected in parallel to the second capacitor to receive a strobe signal generated by a controller on a request made by an ambient light sensor for measuring ambient light parameters;
wherein during the normal operating mode, the drain terminal of the first field effect transistor is at higher voltage than the source voltage and the LED array is in ON state and when the request is made by ambient light sensor the controller turns ON the second field effect transistor which pulls down the voltage at the gate terminal of the first field effect transistor which turns off the LED array.

7. The LED lighting system of claim 6, wherein the first field effect transistor remains open during normal operating state and the LED array remains ON.

8. The LED lighting system of claim 6, wherein the capacitor placed in parallel to the LED array has a rating of 10 uF to 100 uF.

9. The LED lighting system of claim 6, wherein the power converter is a buck converter, a flyback converter or single-ended primary-inductor converter (SEPIC), a linear converter or a resonant converter.

10. The LED lighting system of claim 6, wherein the first field effect transistor and the second field effect transistor are a metal-oxide-semiconductor field effect transistors (MOSFET).

11. The LED lighting system of claim 6, wherein the power converter further comprises means that can be asserted by a pulse width modulating signal to switch off the supply to the LED array.

12. The LED lighting system of claim 6, wherein the strobe signal is of 50 us to 150 us.

13. A LED lighting system with built-in intelligence comprising:
a power converter to control the dimming of an LED array in response to feedback received from one or more monitoring sensors;
a bridge rectifier to convert AC power coming from an external source to DC power for the power converter;
a first capacitor connected in parallel with input to the bridge rectifier; and
a second capacitor connected in parallel to a series combination of said first capacitor and a diode for alternating current (DIAC).

14. The LED lighting system of claim 13, wherein an additional series combination of a capacitor and a diode for alternating current is connected in parallel with the first capacitor and in parallel to the bridge rectifier.

15. The LED lighting system of claim 13, wherein a controlling unit dims off the LED array on receiving instructions from said one or more monitoring sensors while the LED lighting system draws a little power.

16. The LED lighting system of claim 13 wherein the first capacitor has a rating of 50-300 nF.

17. The LED lighting system of claim 13 wherein the second capacitor has a rating of 1-10 nF.
